(19) United States
(12) Patent Application Publication
(10) Pub. No.: US 2007/0079502 A1
(43) Pub. Date: Apr. 12, 2007

(54) Convenient auto-assembling system for small shell devices

(75) Inventors: Shin Ming Wang, Taipei City (TW); Chih Peng Yang, Jhongli City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Chung Yuan Christian University

(21) Appl. No.: 11/231,508

(22) Filed: Sep. 21, 2005

(51) Int. Cl. B23P 21/00

(52) U.S. Cl. 29/771

(57) ABSTRACT

The present invention discloses an auto-assembling system for assembling the frames and the covers of devices, completely. The auto-assembling system configured on a platform includes a transportation device, a lateral assembling power module, a buffer, a control circuit and a power source. The above-mentioned transportation device has a fillister for receiving the frames and the covers of the devices. The frames that are combined with the covers in the transportation device are driven by the horizontal assembling power module. The buffer is used as a cushion for the lateral assembling power module. When the lateral assembling power module moves to the buffer, it causes the frames and the covers to be assembled. The control circuit connects to the lateral assembling power module for controlling the activating timing of the foregoing lateral assembling power module. The power source connects to the lateral assembling power module and the control circuit to provide the power for them.

### FIELD OF THE INVENTION

The present invention relates generally to an auto-assembling system, and more specifically to an auto-assembling system that combines the motor and the machine utilized to auto-assemble and collect the frames and the covers of the electronic devices.

### BACKGROUND OF THE INVENTION

The mobile phone industry of Taiwan can be substantially divided into two segments. One is the up stream industry for providing the components and another segment involves the manufacture of the mobile phone. As to the up stream industry, for examples, includes the printed circuit board (PCB), connecter, the housing, the key board, the panel, etc. Because of the product quality is better than other areas, the manufacture costs in Taiwan are also lower than the one of the supplier in Europe, America and Japan, thus, the goods made by Taiwan is graced by the overseas merchants. In the manufacture of the mobile phone, owing to the reduction of the selling price of the mobile phone in GSM at present, and the prices of mobile phone still decline every year forced the mobile phone factories to lower the overhigh manufacture and its costs.

Under the circumstance of the growing sales of the mobile phone with each passing day, the demands of the amounts every year are about at least six hundred million, and the demands in Taiwan are ten millions. To face the huge amounts of products, every electronics and information factory is conscious of the lack of the employees, the human resources and the increasing of the production costs, and transfers the manufacture factories to abroad.

As to the regard of the competition, the Taiwan factories receive the orders of the foreign factories under the trend of the low price in the mobile phone, consequently, the ability of lowering the costs is naturally important. Hence, Taiwan manufacture factories are enforced to urgently improve their production ability, such that they can consolidate their pass orders and not snatched by China which having the predominance in manufacture.

In the past, the part of the assembling production was almost operated by the manpower. The traditional assembling production line and the collecting operation of the devices are low efficiency, a lot of working space and taking the wrong collection by personal negligence, such that they always receive the complaints from customers or the factories suffer the damages. And many workers are needed in a production line and these will raise the costs of manufacture. As know in art, the efficiency of the assembling operation by manual is about one product per two seconds. That is to say, working for eight hours every day can accomplish the production amounts of 8 (hours)×60 (minutes)×60 (seconds)/2 (seconds)=14,400 products/day, an ideal amount of the production calculated by a nonstop worker, but actually each worker always needs to take rest. Nevertheless, each works needs working space and will be paid.

However, under the consideration of high quality products, the automatic equipments are adopted in production testing processes to improve the yields of the products through the changes of the manufacture flows. The yields improvement is the key to the costs reduction. If the production is transferred to abroad, they must face the problems of the retraining of the employees and the improvement of the learning curve. These problems are the obstructers of the improvement of the yield.

In view of above-mentioned, the efficiency of the traditional laboring work is not high and a large number of operators are needed at the same time. These reflect on the manufacture cost. However, lowering the cost, saving the space and reaching the same capability for production are not achieved by the management of manpower. Therefore, take a step to automatize the production can qualify and improve the capacity for production, lower the production cost and raise the profit.

Corresponding to the division of labor of the information industry, the manufacture industry of the mobile phone is a highly integrated sunrise industry. Thereof, the automated operation mode of manufacture is fit for the demands of the product production in modern industry (various product, short life time, product qualification and various and a few product) to improve the capability of competition.

The object of the present invention is to provide an auto-assembling system integrating the above-mentioned demands and utilized to auto-assemble the devices to improve the whole production efficiency. That can be used on the auto-assembling system in the production line, and molded upon on the production of the various shell devices to overcome the overhigh problems of the manpower and the production costs.

### SUMMARY OF THE INVENTION

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims. Then, the components of the different elements are not shown to scale. Some dimensions of the related components are exaggerated and meaningless portions are not drawn to provide a more clear description and comprehension for the present invention.

In view of above-mentioned, the object of the present invention is to disclose an auto-assembling system for assembling the frames and the covers of the devices by combining the motor and the control circuit.

Another object of the present invention is to disclose a conveniently auto-assembling system for assembling the frames and the covers of the devices, collecting efficiently and lowering the risk of gaining not equal to the production corresponding to the placement of the a number of labors.

The present invention discloses an auto-assembling system for assembling the frames and the covers of devices. The auto-assembling system configured on a platform includes a transportation device, a lateral assembling power module, a buffer, a control circuit and a power source. The above-mentioned transportation device has a fillister for receiving a frame and a cover of a device. A lateral assembling power module responds to the transportation device to drive the frames and the covers in the transportation device, so that the frames and the covers are substantially combined with each other. A buffer is used as a cushion for a lateral assembling power module, when the lateral assembling power module move to the buffer, the frames and the covers are assembled. A control circuit connects to the lateral assembling power module for controlling the activating timing of the lateral assembling power module. A power source connects to the lateral assembling power module and the control circuit to provide the power for the lateral assembling power module and the control circuit.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a diagram of an auto-assembling system according to the present invention.

FIG. 2 illustrates a diagram of an impact hammer driven by a lateral assembling power module to bump into the frames and the covers in the transportation devices according to the present invention.

FIG. 3 illustrates a diagram of the buffer used as a cushion for an impact hammer according to the present invention.

FIG. 4 illustrates a diagram of a collector opening of the devices according to the present invention.

FIG. 5 illustrates a diagram of a frame transportation device according to the present invention.

FIG. 6 illustrates a diagram of a cover transportation device according to the present invention.

FIG. 7 illustrates a diagram of a frame according to the present invention.

FIG. 8 illustrates a diagram of a cover according to the present invention.

FIG. 9 illustrates a diagram of an impact hammer according to the present invention.

FIG. 10 illustrates a diagram of the related sizes of a transportation device according to the present invention.

FIG. 11 illustrates a diagram of the related sizes of a cover transportation device according to the present invention.

### DETAILED DESCRIPTION OF THE PREFERRED EMBODIMENT

Referring now to the drawings and the following description wherein the showings and description are for the purpose of illustrating the preferred embodiments of the present invention only, and not for the purpose of limiting the same. Then, the devices of the different elements are not shown to scale. Some dimensions of the related devices are exaggerated and meaningless portions are not drawn to provide a more clear description and comprehension of the present invention.

Thereafter, it provides many definite descriptions to provide the through understanding of the embodiments of the present invention. Referring to the drawings and the following description, wherein the showings and the description are for the purpose of illustrating the preferred embodiments of the present invention only, and not for the purpose of limiting the same.

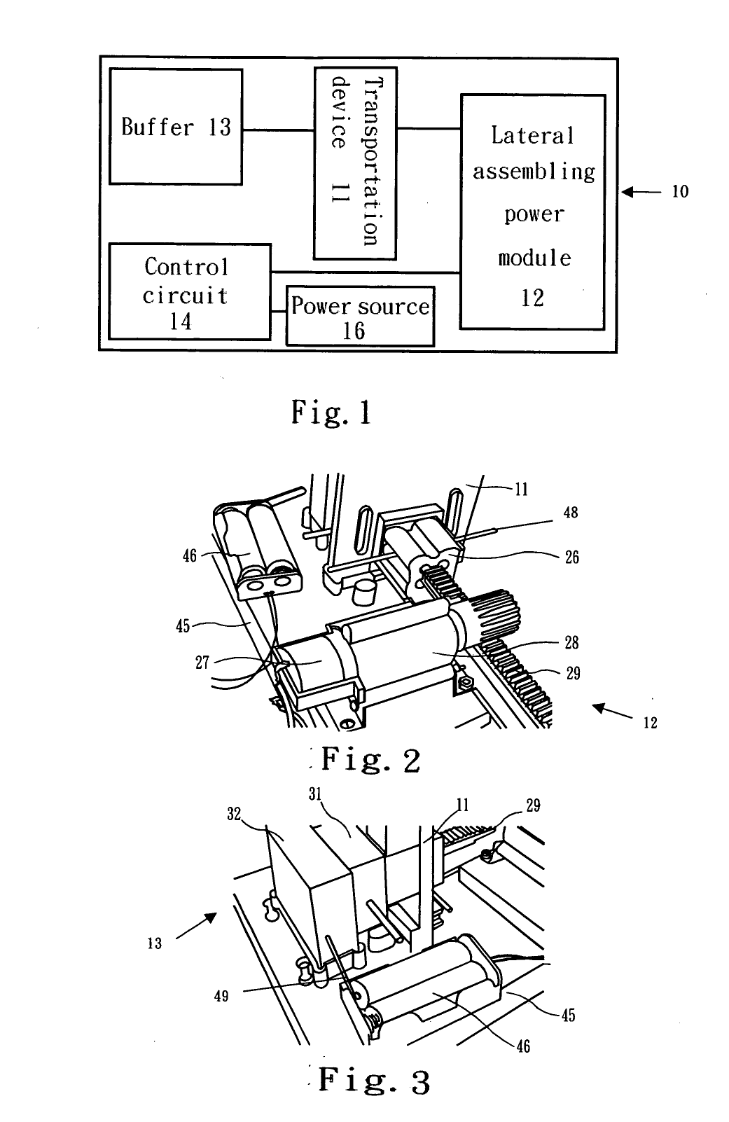

Please refer to FIG. 1, it illustrates a diagram of an auto-assembling system 10 that includes the motor and control circuit of the present invention configured on a platform 45, and assembles the frames and the covers of the devices.

As showed in FIG. 1, the auto-assembling system 10 includes a transportation device 11, a lateral assembling power module 12, a buffer 13, a control circuit 14 and a power source 46. The transportation device 11 has a fillister for holding the frames 15 and the covers 16. The frames 15 combined with the covers 16 in the transportation device 11 are driven by the above-mentioned lateral assembling power module 12. The buffer 13 is used as a cushion for a lateral assembling power module 12. When the lateral assembling power module 12 moves to the buffer 13, it causes that the frames 15 and the covers 16 can be assembled. The control circuit 14 is coupled to the lateral assembling power module 12 for controlling the activating timing of the foregoing lateral assembling power module 12. The power source 46 is coupled to the lateral assembling power module 12 and the control circuit 14 to provide the power for them.

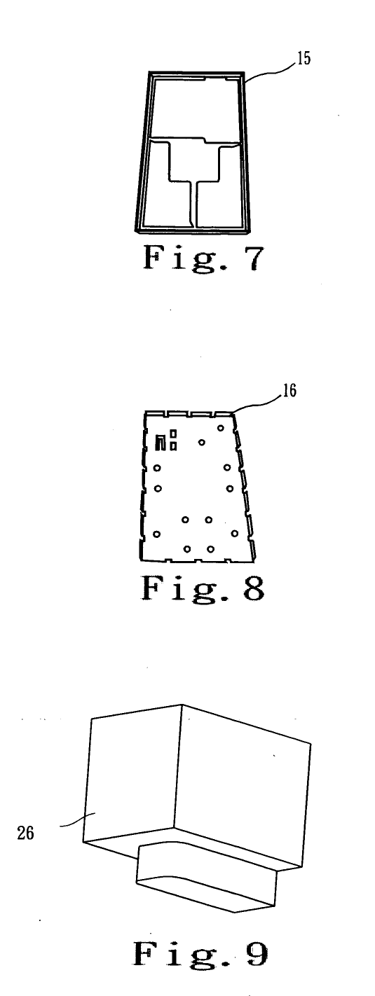

Please refer to FIGS. 5 and 6, the transportation device 11 includes a frame transportation device 17 and a cover transportation device 18, respectively transport the frames 15 and the covers 16, as showed in FIGS. 7 and 8. The gravity of the frames 15 and the covers 16 are utilized to transport the frames 15 and the covers 16. Simultaneously, referring to FIG. 2, when the frames 15 and the covers 16 fell from the transportation device 11, the frames 15 and the covers 16 are acted the lateral motion driven by the lateral assembling power module 12.

As showed in FIG. 2, the lateral assembling power module 12 includes a motor 27, a planetary gear set 30, gears 28, racks 29 and the impact hammer 26. The above-mentioned motor 27 is connected to the gears 28, and the gears 28 connect to the racks 29. The front of the above-mentioned racks 29 is connected to the impact hammer 26. The impact hammer 26 is T-shape and has a first pull rod on both sides. The lateral assembling power module 12 impacts the frames 15 and the covers 16 in the transportation device 11 and driven by the impact hammer 26 to act the lateral motion.

In one embodiment, the motor 27 includes a direct current (DC) motor. In another embodiment, the advantages of the DC motor are easy obtainment and lower costs, and the DC motor combining with the gears 28 can lower the rotational speed in small space and simultaneously improve the torque. The modulus of the gears 28 matching to the modulus of the racks 29 are configured on an output axis. The motor 27 connects to the planetary gear set 30, and the planetary gear set 30 connects to the gears 28, and the gears 28 connect to the racks 29. The impact hammer 26 is driven by the racks 29, so that the frames 15 and the covers 16 act in later motion. Wherein, the motor 27 could be operated in clockwise and counterclockwise direction, alternatively, such that the motor can be performed continuously.

Please refer to FIG. 3, the buffer 13 includes an impact chunk 31 and a block 32, and the impact chunk 31 has a second pull rod 49 on both sides. In one embodiment, the impact chunk 31 can slide on the platform 45 due to its own second pull rod 49, and the block 32 is fixed on the platform 45.

In another embodiment, the second pull rod 49 on both sides of the impact chunk 31 simultaneously act the frames 15 and the covers 16 in later motion by connecting to the first pull rod 48 on both sides of the impact hammer 26. The objective of the impact chunk 31 is acted as the cushion for the impact hammer 26, and the objective of the block 32 is used to cushion the impact again.

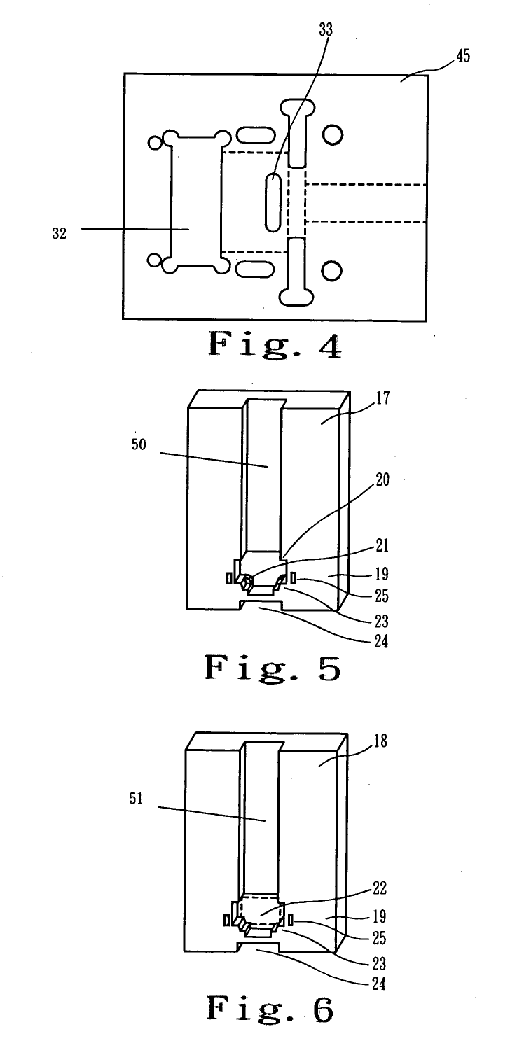

As showed in FIG. 4, the above-mentioned auto-assembling system 10 further includes a collector opening 33 configured on the platform 45 for collecting the combination of the frames 15 and the covers 16. In one embodiment, the platform 45 includes a plurality of the openings, so that the transportation device 11 and the buffer 13 can be tightly integrated with the platform 45. For examples, the bottom portion of the transportation device 11 is shaped in [symbol] -shape and is embedded into the opening of the platform 45, and act as the cushion for the impact hammer 26 again.

Please refer to FIGS. 5 and 6, the transportation device 11 includes the frame transportation device 17 with a first fillister 50 and the cover transportation device 18 with a second fillister 51, respectively transport the frames 15 and the covers 16, as showed in FIGS. 7 and 8. For example, the frame transportation device 17 and the cover transportation device 18 are the open modules and their objectives are reducing the manufacture costs of the modules and materials.

In one embodiment, the frames 15 and the covers 16 are transported because of its gravity by the auto-assembling system 10. In another embodiment, the frames 15 and the covers 16 include but not limited to the type and size of the frames 15 and the covers 16 of the embodiment showed in the drawing. Modification and various changes can be made therein by person skilled in the art under the spirit and scope of the present invention.

In yet another embodiment, the frame transportation device 17 with the first fillister 50 and the cover transportation device 18 with the second fillister 51 are arranged in substantially parallel. The frames 15 and the covers 16 in the transportation device 11 are separated, therefore, the arrangements of the frames 15 and the covers 16 are not disordered, and the frames 15 and the covers 16 can be assembled precisely when a plurality of the frames 15 and the covers 16 are arranged in the transportation device 11.

As showed in FIG. 5, the frame transportation device 17 includes a chunk against front fall 20 used to prevent the frames 15 from the forward falling when they fell into a orientation section 19 from the frame transportation device 17. The foregoing frame transportation device 17 includes a chunk against sliding 21, and its objective is to prevent the sliding of the frames 15. As showed in FIG. 6, the cover transportation device 18 includes a block against back fall 22 configured in front of the second fillister 51.

Please refer to FIGS. 5 and 6, the frame transportation device 17 and the cover transportation device 18 respectively include a orientation section 19 as the orientation position of the frames 15 and the covers 16. And the both sides of the orientation section 19 have the orientation openings for the pull rod 25.

The frame transportation device 17 and the cover transportation device 18 respectively include a sloping base 23 and their objectives allow the frames 15 and the covers 16 arriving the orientation along the sloping base 23. Then, the bottom portions of the frame transportation device 17 and the cover transportation device 18 are configured in [symbol] -shape 24, and the movements of X and Y axis of the frames 15 and the covers 16 are limited and the movement of Z axis of the frames 15 and the covers 16 is limited by its gravity.

In yet another embodiment, the frames 15 and the covers 16 can be connected tightly with each other because of the block against back fall 22 connected by the first pull rod 48, the second pull rod 49, and the connecting rope through the orientation openings for the pull rod 25, and prevent the frames 15 and the covers 16 from the back falling or dropping due to fall when they fell into the orientation section 19.

For example, the orientation openings for the pull rod 25 of the transportation device 11 connect with the first pull rod 48 on both sides of the impact hammer 26 of the lateral assembling power module 12 and the second pull rod 49 on both sides of the buffer 13, and so that the auto-assembling system 10 can be operated stably.

In one embodiment, the control circuit 14 includes a photo interrupter configured on the platform 45 and used to determine whether the impact hammer 26 and the impact chunk 31 reach the predetermined position and as the sensor of the control circuit 14.

In another embodiment, the control circuit 14 includes a microprocessor 8051 single chip used to control the process. For example, the above-mentioned control circuit 14 further includes the resistance, the capacitor, the switch and the oscillator, etc.

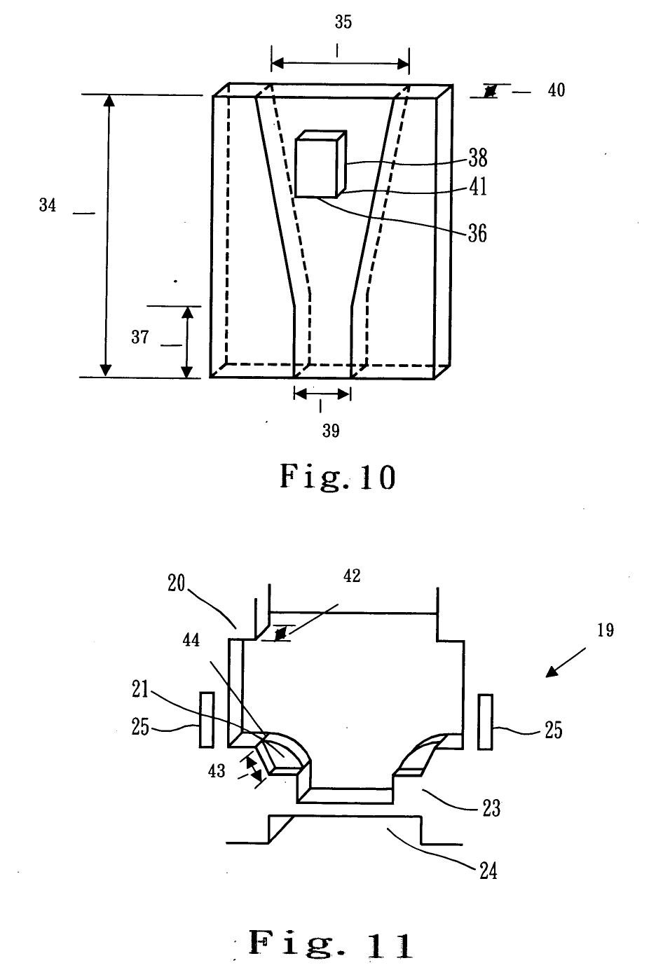

Please refer to FIG. 10, the first fillister 50 and the second fillister 51 are wider on the top portion and narrower at the bottom portion, and utilized to easily put the frames 15 and the covers 16 into the transportation device 11. When the frames 15 and the covers 16 fell from the transportation device 11 by gravity, they can be transported to the orientation section 19. In one embodiment, the first fillister 50 and the second fillister 51 are trapezoid fillisters, and used to prevent the frames 15 and the covers 16 from be falling outside from the transportation device 11.

In one embodiment, the sizes of the transportation device 11 are determined by the sizes of the frames 15 and the covers 16. The designs related the sizes of the transportation device 11, for instance, are showed as following:

the total length of the transportation device 34=depend on the numbers of the frames 15 (or the covers 16) putted into the transportation device.

the upper width of the transportation device 35=(the width of the frames 15 (or the covers 16) 36+the positive errors of the frames 15 (or the covers 16))×150%

the length of the fixed track 37=¾ the length of the frames 15 (or the covers 16) 38

the lower width of the transportation device 39=(the width of the frames 15 (or the covers 16) 36+the positive errors of the frames 15 (or the covers 16))×101%

the depth of the transportation device 40=the thickness of the frames 15 (or the covers 16) 41×102%

In one embodiment, the frames 15 and the covers 16 fall along the length of the fixed track 37 and reach the orientation position when they fall and precisely approach the orientation section 19.

As showed in FIG. 11, the designs related the sizes of the frame transportation device 17, for example, are showed as following:

the designed height for against front fall 42=the designed height for against sliding 43= 1/7 the length of the frames 15 (or the covers 16) 38

the designed width for against sliding 44=⅙ the width of the frames 15 (or the covers 16) 36

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. An auto-assembling system, comprising:
a transportation device having a fillister for receiving a frame and a cover of a device;
a lateral assembling power module responsive to said transportation device to drive said frames and said covers in said transportation device, so that said frames and said covers are substantially combined with each other;
a buffer, used as a cushion for said lateral assembling power module, when said lateral assembling power module move to said buffer, said frames and said covers are assembled;
a control circuit connected to said lateral assembling power module for controlling the activating timing of said lateral assembling power module; and
a power source connected to said lateral assembling power module and said control circuit to provide the power for said lateral assembling power module and said control circuit.

2. The auto-assembling system of claim 1, wherein said lateral assembling power module includes a motor connected to gears, and said gears being connected to racks, and the front of said racks being connected to said impact hammer, and said impact hammer being T-shape and having a first pull rod on both sides.

3. The auto-assembling system of claim 1, wherein said transportation device includes a frame transportation device with a first fillister and a cover transportation device with a second fillister.

4. The auto-assembling system of claim 3, wherein said frame transportation device and said cover transportation device are arranged in substantially parallel.

5. The auto-assembling system of claim 3, wherein said first fillister and said second fillister are wider on the top portion and narrower at the bottom portion.

6. The auto-assembling system of claim 3, wherein said frame transportation device includes a first chunk against front fall.

7. The auto-assembling system of claim 3, wherein said frame transportation device includes a second chunk against sliding.

8. The auto-assembling system of claim 3, wherein said cover transportation device includes a first block against back fall.

9. The auto-assembling system of claim 3, wherein said cover transportation device includes a first block against back fall placed before said second fillister.

10. The auto-assembling system of claim 3, wherein said frame transportation device and said cover transportation device respectively include an orientation section.

11. The auto-assembling system of claim 10, wherein said orientation section has an orientation opening for pulling rod on both sides.

12. The auto-assembling system of claim 3, wherein said frame transportation device and said cover transportation device respectively include a sloping base.

13. The auto-assembling system of claim 3, wherein the bottom of said frame transportation device and said cover transportation device are shaped in [symbol] -shape.

14. The auto-assembling system of claim 2, wherein said motor includes a DC motor.

15. The auto-assembling system of claim 1, wherein said buffer includes an impact chunk and a block, wherein said impact chunk have a second pull rod in both sides.

16. The auto-assembling system of claim 1, wherein said auto-assembling system further comparing a collector opening used to collect said frames and said covers of said assembled devices.
